(19) United States
(12) Patent Application Publication
(10) Pub. No.: US 2025/0374007 A1
(43) Pub. Date: Dec. 4, 2025

(54) ELECTRONIC TRACKING DEVICES

(71) Applicant: Hapn Holdings Inc., Long Island City, NY (US)

(72) Inventor: Misti Dee Moss, Tampa, FL (US)

(21) Appl. No.: 19/223,827

(22) Filed: May 30, 2025

Related U.S. Application Data
(60) Provisional application No. 63/655,962, filed on Jun. 4, 2024.

(51) Int. Cl. H04W 4/029; H04W 4/80

(52) U.S. Cl. CPC H04W 4/029; H04W 4/80

(57) ABSTRACT

Systems, devices, and methods for monitoring an electronic tracking device are described. In one example method, an electronic tracking device determines that the electronic tracking device is moving. After determining that the electronic tracking device is moving, the electronic tracking device determines that the electronic tracking device is not communicatively connected to one or more wireless networks. In response to determining that the electronic tracking device is not communicatively connected to the one or more wireless networks, the electronic tracking device determines location information of the electronic tracking device and sends the location information.

### CLAIM OF PRIORITY

This application claims priority under 35 USC § 119(e) to U.S. Patent Application Ser. No. 63/655,962, filed on Jun. 4, 2024, the entire contents of which are hereby incorporated by reference.

### TECHNICAL FIELD

The present disclosure relates generally to electronic tracking devices, and, in particular embodiments, to electronic tracking devices operating within wireless networks.

### BACKGROUND

Security tags used in merchandise are electronic tracking devices attached to retail items to prevent theft. They come in various forms, such as hard tags, soft tags, and ink tags, among others. Hard tags are typically made of plastic and are attached to the product using a pin. Soft tags are adhesive labels with embedded electronic components. Ink tags contain a vial of ink that spills if forcibly removed, damaging the item. These tags set off alarms if not deactivated or removed at checkout, providing a deterrent against shoplifting.

### SUMMARY

The present disclosure describes methods, devices, systems, and techniques for monitoring and locating an electronic tracking device.

In a general aspect, a method for monitoring an electronic tracking device includes: determining, by an electronic tracking device, that the electronic tracking device is moving; after determining that the electronic tracking device is moving, determining, by the electronic tracking device, that the electronic tracking device is not communicatively connected to one or more wireless networks; in response to determining that the electronic tracking device is not communicatively connected to the one or more wireless networks, determining, by the electronic tracking device, location information of the electronic tracking device; and sending, by the electronic tracking device, the location information.

Particular embodiments may include one or more of the following features.

In some embodiments, the location information includes a Global Positioning System (GPS) location of the electronic tracking device.

In some embodiments, determining, by an electronic tracking device, that the electronic tracking device is moving includes: determining that the electronic tracking device is moving at a first time point. Determining, by the electronic tracking device, that the electronic tracking device is not communicatively connected to one or more wireless networks includes: determining that the electronic tracking device is not communicatively connected to the one or more wireless networks at a second time point, wherein a time period between the first time point and the second time point is a predetermined time period.

In some embodiments, the method further includes: determining, by the electronic tracking device, that a predetermined time period has lapsed without detecting any movement of the electronic tracking device during the predetermined time period; and in response to determining that the predetermined time period has lapsed without detecting any movement of the electronic tracking device during the predetermined time period, determining, by the electronic tracking device, location information of the electronic tracking device.

In some embodiments, the one or more wireless networks include a Bluetooth mesh network comprising a plurality of Bluetooth beacons. In such embodiments, determining that the electronic tracking device is not communicatively connected to the one or more wireless networks includes: determining that the electronic tracking device is not paired with any Bluetooth beacon of the plurality of Bluetooth beacons in the Bluetooth mesh network.

In some embodiments, the one or more wireless networks include a first wireless network and a second wireless network, the first wireless network is a Bluetooth mesh network comprising a plurality of Bluetooth beacons, and the second wireless network is a Wi-Fi network. In such embodiments, determining that the electronic tracking device is not communicatively connected to the one or more wireless networks includes: determining that the electronic tracking device is not paired with any Bluetooth beacon of the plurality of Bluetooth beacons in the first wireless network; in response to determining that the electronic tracking device is not paired with any Bluetooth beacon of the plurality of Bluetooth beacons in the first wireless network, determining whether the electronic tracking device is communicatively connected to the first wireless network; and in response to determining that the electronic tracking device is not communicatively connected to the first wireless network, determining that the electronic tracking device is not communicatively connected to the second wireless network.

In another aspect, an electronic tracking device includes: a motion sensor, a Bluetooth circuitry, a GPS circuitry, at least one processor, and one or more memories coupled to the at least one processor. The one or more memories store programming instructions for execution by the at least one processor to perform the above-described method.

In yet another aspect, a non-transitory computer-readable storage medium stores programming instructions for execution by at least one processor of an electronic tracking device to perform the above-described method.

The details of one or more embodiments of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

For a more complete understanding of the present disclosure, reference is now made to the following descriptions taken in conjunction with the accompanying drawings.

FIGS. 1A-1C illustrate an example electronic device, according to one or more embodiments of the present disclosure.

FIG. 2 illustrates an example electronic device, according to one or more embodiments of the present disclosure.

FIG. 3 illustrates an example charging station, according to one or more embodiments of the present disclosure.

FIG. 4 illustrates an example Bluetooth network, according to one or more embodiments of the present disclosure.

FIG. 5 illustrates an example Wi-Fi network, according to one or more embodiments of the present disclosure.

FIG. 6 illustrates an example process, according to one or more embodiments of the present disclosure.

### DETAILED DESCRIPTION

Security tags are widely used in retail environments as part of Electronic Article Surveillance (EAS) systems to deter theft and unauthorized removal of merchandise. These tags, which are attached to items during display or storage, incorporate electronic or mechanical components that interact with detection systems located at store exits. Common designs include reusable hard tags for high-value items, single-use adhesive soft tags for smaller goods, and ink-based tags that release a permanent dye if forcibly removed. Upon purchase, these tags are either deactivated or detached at the point of sale to allow safe and authorized removal from the store premises.

The functionality of security tags is primarily based on their interaction with detection technologies such as Radio Frequency (RF), Acousto-Magnetic (AM), or Electromagnetic (EM) systems. These technologies can ensure that any tagged item passing through the detection zone without proper deactivation triggers an alarm, alerting store personnel to potential theft. Modern advancements have integrated Radio Frequency Identification (RFID) technology into security tags, enabling simultaneous theft prevention and real-time inventory tracking to enhance retail operations and reduce losses.

The present disclosure offers a more precise theft detection system. By utilizing Bluetooth-enabled proximity detection within the store and transitioning to Global Positioning System (GPS) tracking when items are determined to have left the designated area, techniques as described in the present disclosure can enhance the accuracy, efficiency, and range of retail merchandise monitoring.

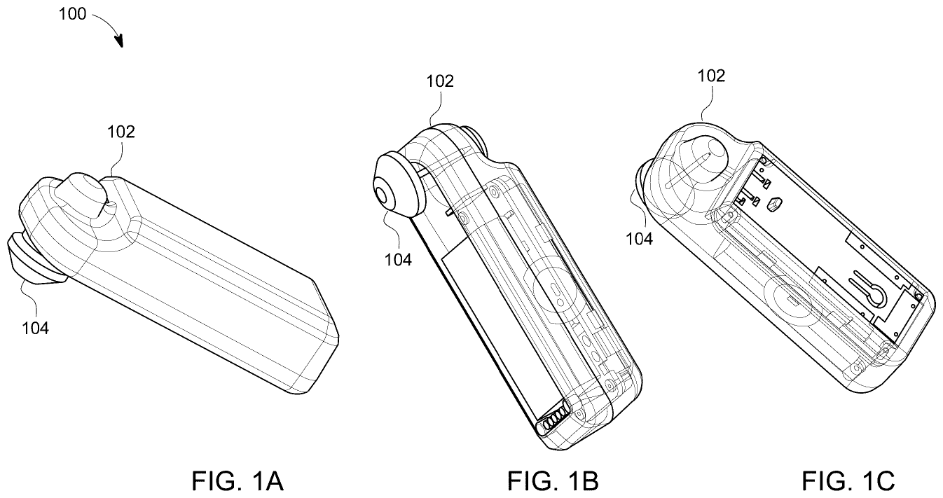

FIGS. 1A-1C illustrate an example electronic tracking device 100, according to one or more embodiments of the present disclosure. In some embodiments, the electronic tracking device 100 is configured as a security tag. For example, the electronic tracking device 100 can be configured to monitor the location of valuable items, such as merchandise in retail environments, equipment in industrial facilities, or personal belongings in transit.

As shown in FIG. 1A, the electronic tracking device 100 includes a body 102 and a pin 104. In some embodiments, the body 102 includes one or more of a housing, electronic circuitries, antennas, a locking mechanism, or a deactivation mechanism. In some examples, the housing of the body 102 can be made of plastic, metal, or composite materials. The electronic circuitries of body 102 can include one or more of a GPS circuitry, a Wi-Fi circuitry, a Bluetooth circuitry, a battery, at least one processor, and one or more memories storing programming instructions. In some examples, the electronic circuitries of the body 102 can be based on different technologies, such as Radio Frequency (RF), Acousto-Magnetic (AM), or Electromagnetic (EM).

In some examples, the body 102 can include ink vial that will break and stain the item if the electronic tracking device 100 is forcibly removed.

In some embodiments, the pin 104 is used to attach the electronic tracking device 100 to an item, for example, by piercing through the fabric or attaching to a designated part of the item. The electronic tracking device 100 can be attached using any suitable method of attachment, including but not limited to a pin, or loop, or magnetic mechanism.

The electronic tracking device 100 can be deployed in various forms, including spider tags and RFID components. The electronic tracking device 100 can have a small and discreet design, making them easily attachable to merchandise without being obtrusive. A concealed quick response (QR) code or other identification code can be placed under the pin 104 for easy identification. In some examples, the electronic tracking device 100 can include a wireless identifier, allowing other devices to wirelessly connect to and identify the security tag.

The electronic tracking device 100 can be configured to operate on a battery. In some examples, the electronic tracking device 100 can be configured to alternate between passive monitoring using Bluetooth for proximity detection and active tracking using GPS when it loses visibility of the Bluetooth network.

In some examples, the electronic tracking device 100 can be connected to a mesh network, e.g., a Bluetooth mesh network or a Wi-Fi mesh network, to conserve battery life, which may also allow for relatively smaller batteries than other potential solutions.

In some embodiments, Bluetooth beacons are placed throughout a predetermined area, such as a retail store, to provide a Bluetooth mesh network. In some examples, the electronic tracking device 100 can be disguised as regular or traditional tags to remain inconspicuous and deployed on frequently stolen assets. In some examples, while within the predetermined area, the electronic tracking device 100 can remain in an idle mode to preserve battery life. When the electronic tracking device 100 leaves the area and disconnects from the Bluetooth mesh network, either by theft or failure to disable the tag after purchase, the electronic tracking device 100 can transition from the idle mode to an active tracking mode and periodically transmit its GPS location. This approach can enable continuous tracking of stolen goods to their final destination.

For example, within a predefined retail zone, the electronic tracking device 100 can use Bluetooth to detect proximity to designated beacons, maintaining low power consumption. If electronic tracking device 100 no longer detects any registered Bluetooth beacons, potentially indicating that the merchandise has been moved outside the predefined retail zone, the electronic tracking device 100 can switch to GPS tracking. This transition to GPS mode can provide more accurate location tracking and boundary alerts, enabling effective monitoring of merchandise outside the store.

Upon losing visibility of the Bluetooth beacons anchored to the predefined retail area, the electronic tracking device 100 can enter a performance mode, which can, for example, cause the device to report every few minutes (or other suitable period) when in motion and every a few hours (or other suitable period) when stationary. This mode can be useful for real-time and precise location tracking.

In some embodiments, the electronic tracking device 100 can trigger an alerting event when it loses visibility of the Bluetooth beacons anchored to the predefined retail area, allowing the system to generate an immediate alert. In some examples, the electronic tracking device 100 itself can generate the alert, while in others, the loss of the electronic tracking device's 100 connection to one or more Bluetooth beacons can cause a centralized or management system to generate the alert.

In some embodiments, the electronic tracking device 100 further includes a battery management module. In some examples, the battery management module can generate alerts for low battery. In some examples, the electronic tracking device 100 can be charged using a multi-charger pad that allows for multiple trackers to be charged simultaneously, as well as a charging cable for individual charging.

The described techniques can provide relatively longer battery life for the electronic tracking device 100 through periodic GPS reporting and power-saving modes. In some examples, multiple reporting modes can be available for different scenarios, including active pursuit. In some embodiments, users have the flexibility to adjust the reporting modes, including shifting to a battery power-saving mode to further extend battery life according to the situation.

In some examples, the electronic tracking device 100 can be configured to conserve battery life by reporting once per week, or any other suitable period, while within the store, utilizing a predefined power-saving mode. In some examples, the electronic tracking device 100 can last at least a few weeks in this mode by scanning for beacons and providing one GPS report per period.

In some embodiments, a system provided by the described techniques includes a mesh of Bluetooth beacons, multiple trackers, a wireless charging station. In some examples, the mesh network can enhance the management of multiple stores and their security tags by utilizing structured naming conventions and descriptions. Each store, detection device, and security tag can be assigned a unique identifier and descriptive metadata, such as store location, product type, or item status. These identifiers can allow communication between devices, providing efficient inventory grouping and streamlined theft prevention across stores. As new devices or stores are added, the system can remain scalable and organized to provide smooth operation without extensive reconfiguration.

An example tracking process with respect to the electronic tracking device 100 is described as follows. In some examples, the process begins with the electronic tracking device 100, such as a security tag, operating in an idle mode. In the idle mode, the electronic tracking device 100 conserves battery life while passively detecting motion. If the electronic tracking device 100 detects that it is moving, the electronic tracking device 100 transitions to actively scanning for designated Bluetooth beacons within the store.

If the electronic tracking device 100 loses connection with all Bluetooth beacons, the electronic tracking device 100 can alert the system of potential theft by sending a specific message. The message can provide key details, including the unique identifier of the tracking device, its last known location, the timestamp of the event, and the status indicating a loss of connection with all nearby Bluetooth beacons.

In some examples, the electronic tracking device 100 can also attempt to connect to a Wi-Fi network within the store. This Wi-Fi detection can allow the electronic tracking device 100 to establish or re-establish communication with the system, providing an additional opportunity to report its location and status when Bluetooth beacons are unavailable.

If the electronic tracking device 100 is unable to connect to a Wi-Fi network and remains disconnected from all Bluetooth beacons, the electronic tracking device 100 can enter a performance mode. In the performance mode, the electronic tracking device 100 can begin acquiring and transmitting GPS data at a higher frequency to enable precise tracking outside the store environment.

If the electronic tracking device 100 subsequently detects any of the designated Bluetooth beacons, it can revert to the idle mode to conserve battery life. This mode transition can provide efficient power management while maintaining effective tracking capabilities.

The described process can provide efficient and reliable tracking of the electronic tracking device 100. By starting in an idle mode and activating scanning or reporting functions when motion and/or disconnection is detected, the electronic tracking device 100 can improve battery life while remaining responsive to potential theft scenarios. Furthermore, the layered approach of utilizing Bluetooth beacons, Wi-Fi networks, and GPS data can provide robust tracking capabilities across different environments, whether the electronic tracking device 100 is within a store or outside it. Additionally, the integration of multiple communication methods can enhance the likelihood of locating and recovering the tagged item, even if one signal type becomes unavailable. This multi-modal tracking strategy can provide a comprehensive and adaptive solution for theft prevention and merchandise security.

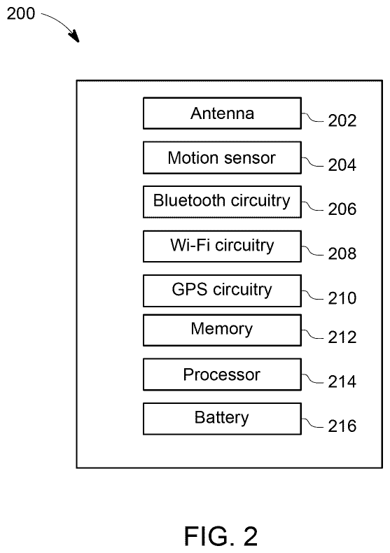

FIG. 2 illustrate an example electronic tracking device 200, according to one or more embodiments of the present disclosure. The electronic tracking device 100 can be an example of the electronic tracking device 100 in FIG. 1.

As shown, the electronic tracking device 200 includes antenna 202, motion sensor 204, Bluetooth circuitry 206, Wi-Fi circuitry 208, GPS circuitry 210, memory 212, processor 214, and battery 216. In some embodiments, the electronic tracking device 200 also incorporates additional components as needed to fulfill the specific requirements of a particular application. Examples of such additional components include tamper-detection mechanisms to alert the system if the device is forcibly removed, encryption modules to secure data transmissions, temperature or humidity sensors for monitoring environmental conditions, or light sensors to detect changes in lighting that may indicate movement from one environment to another, among others. The electronic tracking device 200, as shown in FIG. 2, is illustrated with a single unit for each element for illustrative purposes only. In some embodiments, the device 200 include multiple units of one or more components. For example, depending on specific applications or system requirements, the device 200 can be equipped with multiple memories 212 and multiple processors 214 to enhance performance, improve data processing capabilities, or support additional functionalities.

The antenna 202 can be configured to transmit and receive signals for the operation of the electronic tracking device 200 across Bluetooth, Wi-Fi, and GPS channels. The antenna 202 can provide connectivity with external networks and devices, supporting real-time tracking and communication during its operations.

In some embodiments, the motion sensor 204 is configured to detect physical movement or changes in position within its environment. For example, the motion sensor 204 can operate by sensing vibrations, acceleration, or spatial displacement, depending on the specific technology used, such as accelerometers, gyroscopes, or infrared sensors. In some embodiments, the motion sensor 204 can be configured to detect when the electronic tracking device 200 is in motion, allowing it to transition from idle mode to active scanning. In the active state, the electronic tracking device 200 can begin scanning for Bluetooth beacons or engaging other tracking functions to respond appropriately to changes in its environment. This capability can allow the electronic tracking device 200 to conserve power during periods of inactivity while maintaining responsiveness to events such as theft or unauthorized movement.

In some embodiments, the motion sensor 204 distinguishes between typical handling and consistent motion patterns, offering a dependable method for identifying potentially suspicious activity. For example, typical handling, such as briefly lifting or rotating the device, can generate low-intensity movements over a short duration, which are characteristic of regular use. In contrast, consistent motion patterns, such as prolonged or sustained movement indicative of theft, can produce higher-intensity readings over an extended period, triggering a different response.

In some examples, the motion sensor 204 can utilize accelerometers and gyroscopes to analyze the direction, intensity, and duration of movement, allowing it to recognize distinct motion characteristics. For example, normal handling can result in irregular or small-scale vibrations, whereas theft-related motion can exhibit continuous or directional movement patterns. The electronic tracking device 200 can employ predefined thresholds and algorithms to filter out benign movements while responding appropriately to sustained motion indicative of unauthorized activity. This capability can provide reliable operation in diverse scenarios while reducing false alarms.

In some examples, the movement of the electronic tracking device 200 can be determined by analyzing wireless signals. This can include tracking changes in signal strength, detecting variations in time-of-flight measurements, or using triangulation techniques based on multiple signal sources. For example, the device 200's movement can be inferred from fluctuations in Wi-Fi or Bluetooth signal strength as it moves within a defined space. Similarly, GPS signals or RFID-based tracking can be used to determine location shifts over time.

The Bluetooth circuitry 206 can facilitate wireless communication by transmitting and receiving data over short distances using Bluetooth protocols. In some embodiments, the Bluetooth circuitry 206 can be configured to detect nearby Bluetooth devices, pair with them, exchange data, and maintain stable connections within a specified range. For example, the Bluetooth circuitry 206 can be configured to scan for designated Bluetooth beacons within a predetermined area. These Bluetooth beacons can serve as reference points, allowing the electronic tracking device 200 to determine its location relative to the beacons. When the electronic tracking device 200 is within range of the beacons, the Bluetooth circuitry 206 can communicate its presence and location data to the system. In some examples, the Bluetooth circuitry 206 can provide periodic updates to the system. If the electronic tracking device 200 loses connection with all designated beacons, the Bluetooth circuitry 206 can trigger the transition to alternative communication methods, such as Wi-Fi or GPS, to maintain tracking capabilities.

In some embodiments, the Bluetooth circuitry 206 incorporates Bluetooth Low Energy (BLE) technology. BLE can be used for low-power wireless communication, and Bluetooth circuitry 206 implemented using BLE technology can operate with reduced energy consumption and prolonged operation while maintaining the ability to scan for and communicate with nearby Bluetooth devices. This low-power capability can allow the tracking device 200 to continuously monitor its environment without compromising its battery life, enhancing its overall efficiency and reliability.

In some embodiments, the Wi-Fi circuitry 208 enables the electronic tracking device 200 to connect to wireless local area networks (WLANs) using Wi-Fi protocols. The Wi-Fi circuitry 208 can facilitate communication with networked systems, allowing the transmission and reception of data over larger distances. In some examples, the Wi-Fi circuitry 208 can be configured to function as a complementary communication method alongside Bluetooth connectivity. For example, if the electronic tracking device 200 loses connection with all designated Bluetooth beacons, the Wi-Fi circuitry 208 can scan for available Wi-Fi networks within the store and establish a connection. Once connected, the device 200 can transmit information, such as its location, identifier, and status, to the system. This capability can provide continuous tracking and communication, even in scenarios where Bluetooth signals are out of range.

In some embodiments, the Wi-Fi circuitry 208 supports energy-efficient operation by limiting its activity to situations where Bluetooth connections are unavailable. For example, the electronic tracking device 200 can only activate Wi-Fi functionality when necessary, preserving battery life while maintaining reliable tracking capabilities. By leveraging the broader coverage and higher data capacity of Wi-Fi networks, the Wi-Fi circuitry 208 can enhance the device's ability to operate effectively in complex environments.

In some embodiments, the GPS circuitry 210 is configured to determine the geographic location of the electronic tracking device 200 by receiving signals from a network of GPS satellites. The GPS circuitry 210 can process satellite data to calculate the device 200's position in terms of latitude, longitude, and, in some cases, altitude. In some embodiments, the GPS circuitry 210 is configured to provide location data when the device 200 loses connectivity with Bluetooth beacons and Wi-Fi networks. Upon detecting such a scenario, the device 200 can transition to a performance mode, where the GPS circuitry 210 acquires and transmits location data at a predetermined frequency to provide precise tracking. This capability can allow the device 200 to maintain accurate location information even when it is moved outside the store environment or to areas where other communication methods are unavailable.

The GPS circuitry 210 can also be configured to operate efficiently by activating only when necessary, such as during potential theft events or when other tracking methods cannot provide sufficient location accuracy. This selective activation can help conserve battery life while ensuring that the device remains capable of delivering reliable location data in critical situations. By integrating GPS with Bluetooth and Wi-Fi, the electronic tracking device 200 can achieve a comprehensive and adaptable tracking system that performs effectively across diverse operational scenarios.

In some embodiments, the memory 212 is configured to store data and programming instructions for the operation of the electronic tracking device 200. The memory 212 an include volatile storage, such as random-access memory (RAM), for temporary data processing, as well as non-volatile storage, such as flash memory, for long-term data retention.

The memory 212 can store programming instructions for execution by the processor 214, enabling the proper operation of various components within the device 200. For example, the memory 212 can contain the algorithms used by the motion sensor 204 to distinguish between typical handling and consistent motion patterns or the protocols for managing communication with Bluetooth circuitry 206, Wi-Fi circuitry 208, and GPS circuitry 210. These programming instructions can allow each component of the device 200 to perform its intended functions while interacting with other parts of the device 200.

In some examples, the memory 212 can store configuration data, such as predefined thresholds for motion detection, connection parameters for Bluetooth beacons and Wi-Fi networks, and power management settings for the device 200. The memory 212 can log event data, including motion activity, connection status, and location history, which can be transmitted to the system for analysis or auditing.

The processor 214 can be a versatile processing unit configured to execute various computational tasks for the electronic tracking device 200. In some examples, the processor 214 can be a standard processing unit suitable for multiple applications or a processor specifically designed for the unique functionalities of the tracking device 200. The processor 214 can execute programming instructions stored in the memory 212, enabling the device 200 to perform its intended functions. For example, the processor 214 can process data from the motion sensor 204 to determine whether the device 200 should transition from idle mode to active scanning. The processor 214 can also manage communication protocols for the Bluetooth circuitry 206, Wi-Fi circuitry 208, and GPS circuitry 210, providing integration and efficient use of these components. When theft is detected or the device loses connectivity with designated beacons, the processor 214 can dynamically prioritize tasks, such as activating the GPS circuitry or transmitting alerts to the system.

The processor 214 can also perform real-time decision-making based on incoming data. For example, the processor 214 can analyze motion patterns, evaluate signal strength from Bluetooth beacons and Wi-Fi networks, and improve power usage based on the current operational mode. By adapting its processing capabilities to the specific requirements of the tracking device 200, the processor 214 can provide robust performance, efficient resource management, and reliable tracking functionality in a wide range of scenarios.

In some embodiments, the battery 216 is configured to provide the power for the operation of the electronic tracking device 200. The battery 216 can be a rechargeable or non-rechargeable unit, depending on the design and intended use of the device 200. The capacity and efficiency of the battery 216 can be selected to provide sufficient operational life under typical usage conditions, including extended periods of inactivity and intermittent activation of high-energy components.

The battery 216 can support the energy requirements of the device 200's components, including the motion sensor 204, Bluetooth circuitry 206, Wi-Fi circuitry 208, GPS circuitry 210, memory 212, and processor 214. The device 200 can be designed to improve battery usage by employing power-saving strategies, such as maintaining the device 200 in idle mode during periods of inactivity and only activating components as needed.

In some embodiments, the battery 216 includes monitoring capabilities, allowing the processor 214 to assess its charge level and adjust operational priorities accordingly. For example, the processor 214 can limit non-critical functions or modify data transmission frequency to conserve power when the battery is low. By integrating energy management with power supply capabilities, the battery 216 can ensure that the tracking device 200 remains reliable and effective throughout its operational lifecycle.

In some embodiments, the components of the electronic tracking device 200 include one or more units of each type of component. For example, the device 200 can be equipped with multiple antennas 202 to support different communication frequencies or enhance signal reception. Similarly, the device 200 can include multiple motion sensors 204 for improved sensitivity or redundancy in detecting movement. The Bluetooth circuitry 206 and Wi-Fi circuitry 208 can include additional modules to enable simultaneous communication with multiple devices or networks. The GPS circuitry 210 can incorporate dual-band or multi-channel capabilities to improve location accuracy in diverse environments. Furthermore, the memory 212 can consist of multiple storage units, such as separate modules for temporary and permanent data storage, while the processor 214 can include multiple cores or processors optimized for parallel processing, or to separately control different functionalities of the device 200. The battery 216 can also consist of multiple cells to extend operational life or provide backup power. This modularity and scalability can allow the tracking device 200 to be tailored to meet specific application requirements, enhancing its versatility and functionality.

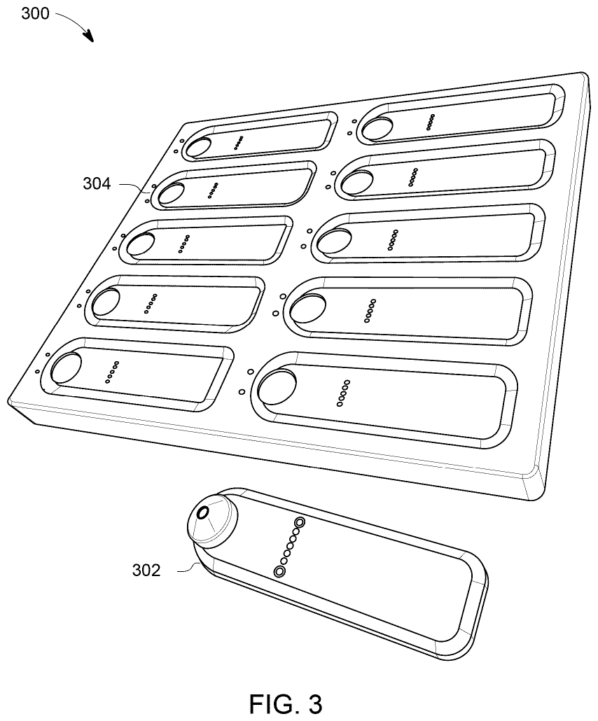

FIG. 3 illustrates an example charging station 300, in accordance with one or more embodiments of the present disclosure. In some embodiments, the charging station 300 is a compact, multi-slot device configured to charge multiple devices, such as electronic tracking device 302, simultaneously. The tracking device 302 can be an example of one or more of the tracking devices 100 and 200.

The charging station 300 includes dedicated charging bays 304, each specifically configured to house an individual device 302. The bays 304 are configured to provide a stable connection between the device 302 and the charging station 300. The charging station 300 can also include visual indicators, such as LED lights, for each charging bay. These indicators can display the charging status of each device, such as charging in progress, fully charged, or an error state, providing users with a clear and immediate understanding of the charging process.

The charging station 300 can incorporate additional features to improve functionality and convenience. For example, the charging station 300 can include an integrated cooling system to prevent overheating during charging or a central power management system to optimize charging speed based on the number of devices connected. The charging station 300 can also support wireless connectivity, allowing it to communicate with a central system to monitor the charging status remotely or log usage data for maintenance purposes.

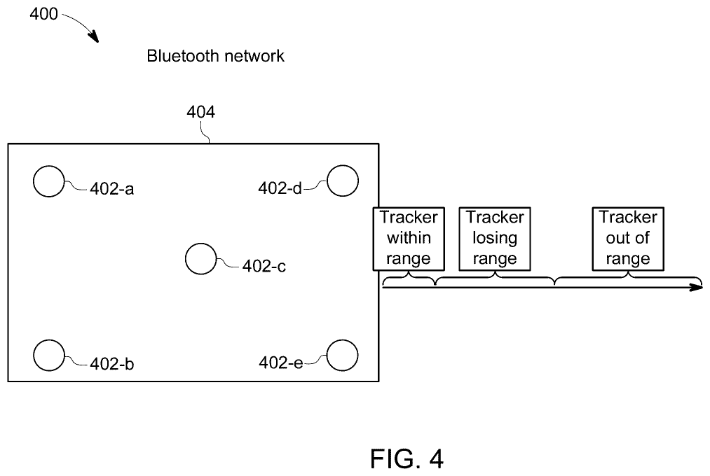

FIG. 4 illustrates an example Bluetooth mesh network 400, in accordance with one or more embodiments of the present disclosure. In general, a Bluetooth mesh network is a wireless communication system that allows multiple Bluetooth devices, such as beacons, to connect and communicate with each other in a decentralized and scalable manner. The Bluetooth mesh network 400 includes multiple Bluetooth beacons, labeled 402-a, 402-b, 402-c, 402-d, and 402-e, collectively referred to as 402. In the illustrated example, the beacons 402-a, 402-b, 402-d, and 402-e are positioned at the four corners of a predetermined area 404, such as a retailer store, while beacon 402-c is centrally located within the area 404. This arrangement demonstrates a configuration that can provide comprehensive coverage within the designated area 404. However, the quantity and arrangement of the beacons are not restricted to this example and can be adapted to suit specific spatial or operational needs.

In some embodiments, the beacons 402 are Bluetooth beacons that transmit signals at regular intervals using Bluetooth Low Energy (BLE) technology. The BLE beacons can be configured to broadcast unique identifiers continuously, allowing BLE-enabled devices, such as security tags or trackers, to detect them and determine their relative proximity. BLE technology can enable the beacons to operate efficiently, providing extended operational life on a single battery while remaining compact and suitable for diverse installation environments. By leveraging BLE signals, the beacons 402 can enhance indoor positioning accuracy and enable real-time tracking of items within the area 404.

A tracking device, such as tracking device 100, 200, or 302, can periodically scan for signals from nearby beacons 402, determining whether the tracking device is within range. The tracking device can receive the unique identifiers transmitted by the beacons 402, enabling it to determine its position within the area 404 and transmit this location data to a central monitoring system. As the tracking device moves closer to or farther from a beacon 402, the changing signal strength can allow for precise monitoring of its location. If the tracking device moves beyond the range of all beacons 402, it can detect the loss of connectivity and trigger an alert, notifying the system that it is leaving the designated area 404.

In some examples, if the tracking device moves entirely out of the beacons' 402 range and is unable to receive their signals, the tracking device can switch to GPS functionality. This transition can provide location tracking without interruption, even outside the beacon-covered area. The integration of BLE beacons with the tracking device can further provide a reliable and energy-efficient mechanism for real-time tracking and monitoring, enhancing the overall functionality and security of the system.

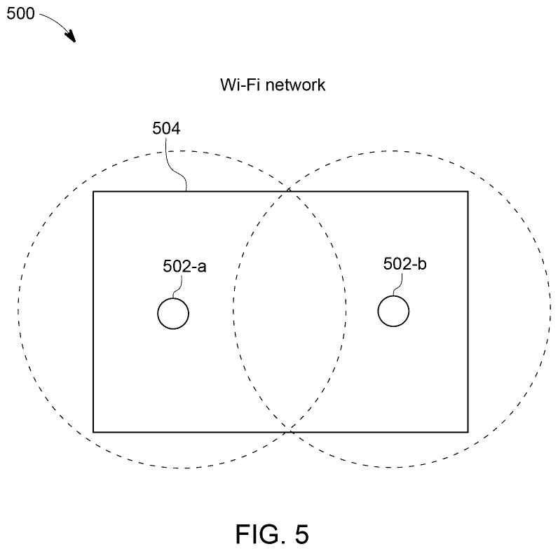

FIG. 5 illustrates an example Wi-Fi network 500, in accordance with one or more embodiments of the present disclosure. In general, a Wi-Fi network is a wireless communication system that enables devices to connect to the internet or other local network resources without the need for physical cables. A Wi-Fi network can operate by transmitting data over radio waves within specified frequency bands, providing connectivity for a wide range of devices, including smartphones, laptops, and IoT devices.

In the illustrated example, the Wi-Fi network 500 includes multiple Wi-Fi access points, labeled as 502-a and 502-b, collectively referred to as 502. In some examples, the Wi-Fi access points 502 can be devices that create and extend wireless coverage by transmitting and receiving radio signals. Each Wi-Fi access point 502 can connect to the broader network infrastructure, such as a router or wired Ethernet network, and serves as an intermediary between wireless devices and the network's central resources. In some embodiments, the Wi-Fi network 500 also includes routers for managing traffic between connected devices and external networks, switches for connecting access points and wired devices, and authentication servers for securing access to the network.

In the illustrated example, the access points 502-a and 502-b are positioned to provide coverage for the entire area 504, such as a retailer store. By overlapping the coverage zones of the access points 502, the Wi-Fi network 500 can provide connectivity across the area 504, allowing devices to maintain uninterrupted communication while moving within the network. However, the number and placement of access points are not limited to this configuration and can be adapted to suit specific spatial or operational needs. In some embodiments, when both the Bluetooth network 400 and the Wi-Fi network 500 are utilized, their respective coverage areas—404 and 504—overlap and cover a designated area, such as a retail store. This overlap can provide seamless connectivity and enhanced tracking capabilities within the specified environment.

In some embodiments, the Wi-Fi network 500 is used in conjunction with tracking devices, such as device 100, 200, or 302, to provide real-time location tracking and data communication. When a tracking device is within the coverage area of the Wi-Fi network 500, the tracking device can connect to one or more access points 502 to transmit its location data, status updates, or alerts to a central monitoring system. If the tracking device moves between the coverage areas of different access points, it can transition connections to provide continuous communication. If the tracking device move out of the Wi-Fi network's range, it can switch to other tracking methods, such as GPS, to maintain location monitoring.

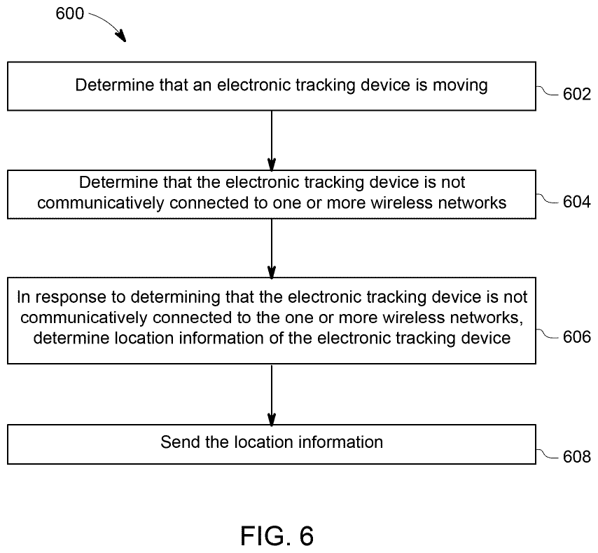

FIG. 6 illustrates an example process 600, according to one or more embodiments of the present disclosure. The process 600 can be performed by an electronic tracking device, such as electronic tracking device 100, 200, or 302.

Electronic tracking devices, such as security tags, are commonly used in retail settings to secure merchandise and deter shoplifting. These devices are designed to monitor the status and location of items, providing alerts or triggering security measures in response to specific events or conditions. One such condition is unauthorized movement, which may indicate an attempt to remove an item without permission. By integrating motion detection capabilities, the tracking device can identify and respond to such activities effectively.

An electronic tracking device determines that the electronic tracking device is moving (602). For example, the electronic tracking device can use an integrated motion sensor (e.g., motion sensor 204), such as an accelerometer, to measure acceleration and detect changes in velocity. When the accelerometer registers movement exceeding a predefined threshold, the electronic tracking device can determine that it is in motion. In some examples, the electronic tracking device can incorporate a gyroscope to detect changes in orientation or angular velocity, which can indicate rotation or other types of movement.

In some embodiments, the electronic tracking device can combine data from multiple sensors, such as accelerometers and gyroscopes, to improve the accuracy of motion detection. For example, the electronic tracking device can analyze both linear acceleration and rotational movement to distinguish between minor vibrations, such as those caused by handling, and sustained motion indicative of transport. In some examples, the electronic tracking device can use vibration sensors to detect environmental disturbances that suggest movement. These motion detection approaches can allow the electronic tracking device to detect a wide range of motion types, from brief handling to continuous transport, enhancing its adaptability across different use cases.

In some embodiments, upon determining that the electronic tracking device is stationary, the device determines whether it is outside a predetermined area, such as a retailer store. In these embodiments, the electronic tracking device checks if it is communicatively connected to specific wireless network(s) associated with the predetermined area. In some embodiments, the electronic tracking device determines that the electronic tracking device is not communicatively connected to one or more wireless networks (604).

In some embodiments, determining that the electronic tracking device is moving comprises determining that the electronic tracking device is moving at a first time point. In such embodiments, determining that the electronic tracking device is not communicatively connected to the one or more wireless networks comprises determining that the electronic tracking device is not communicatively connected to the one or more wireless networks at a second time point, where a time period between the first time point and the second time point is a predetermined time period. This predetermined time period can allow the tracking device to pause momentarily before checking whether it has moved out of range of the store's wireless networks.

This waiting period can allow the solution to ensure that the tracking device does not prematurely determine it has left the store, as it may still be moving within the store boundaries. For example, the tracking device could be in transit between sections of the store where signal strength fluctuates or momentarily drops due to environmental factors. By waiting for this interval, the tracking device can avoid false detections of leaving the store and ensures that only sustained motion away from the store triggers further actions.

In some embodiments, the one or more wireless networks comprise a first wireless network, the first wireless network is a Bluetooth mesh network (e.g., Bluetooth network 400), and the first wireless network comprises a plurality of Bluetooth beacons (e.g., Bluetooth beacons 402). In such embodiments, determining that the electronic tracking device is not communicatively connected to the one or more wireless networks comprises determining that the electronic tracking device is not paired with any Bluetooth beacon of the plurality of Bluetooth beacons in the first wireless network, and, in response to determining that the electronic tracking device is not paired with any Bluetooth beacon of the plurality of Bluetooth beacons in the first wireless network, determining that the electronic tracking device is not communicatively connected to the one or more wireless networks.

For example, a retail store can be equipped with a Bluetooth mesh network comprising multiple Bluetooth beacons placed throughout the store. The electronic tracking device, while operating inside the store, remains paired with one or more of these beacons. As the tracking device moves within the store, it may transition its connection from one beacon to another without losing connectivity, or with only temporary loss of connectivity as the handoff or movement occurs. However, if the tracking device moves toward an exit and leaves the effective range of all Bluetooth beacons, it will no longer be paired with any beacon. At this point, the system or the tracking device can determine that the tracking device is no longer communicatively connected to the Bluetooth mesh network.

As another example, temporary disconnection may occur due to environmental interference. If the tracking device moves to an area with poor signal coverage, such as a storage room with heavy metal shelves that block Bluetooth signals, the tracking device may momentarily lose pairing with all beacons. In this scenario, the tracking device can wait for a predetermined period before confirming that it is out of range of the network, thereby avoiding false disconnection alerts caused by transient signal loss. These mechanisms ensure reliable detection of whether the tracking device is within the network's coverage area.

In some embodiments, each Bluetooth beacon within the Bluetooth mesh network covers a specific region of the store, with all the beacons collectively providing full coverage of the store's area. The tracking device can determine its movement within the store by identifying transitions from one beacon's coverage region to another. This capability can allow the tracking device to monitor its position within the store in real time, providing precise location tracking and operational adjustments based on its location.

In some embodiments, the tracking device periodically checks whether it is still paired with one or more of the beacons, for example, every few minutes. The tracking device can perform multiple checks before concluding its status within the store. For example, if the tracking device detects that it is paired with at least one beacon, it can wait for a predetermined time period before checking again. If, upon rechecking, the tracking device is still paired with at least one of the beacons, it can conclude that it remains within the store. In such examples, the tracking device can enter an idle mode to conserve battery life, as it has confirmed that it is within the store and connected to the wireless network. For example, a tracking device moving through the aisles of a store might momentarily lose connection with one beacon as it transitions to the range of another. By waiting and performing additional checks, the tracking device can avoid false alerts or unnecessary actions caused by transient disconnections.

In some embodiments, the one or more wireless networks comprise a first wireless network and a second wireless network, the first wireless network is a Bluetooth mesh network (e.g., Bluetooth network 400), the first wireless network comprises a plurality of Bluetooth beacons (e.g., Bluetooth beacons 402), and the second wireless network is a Wi-Fi network (e.g., Wi-Fi network 500). In such embodiments, determining that the electronic tracking device is not communicatively connected to the one or more wireless networks comprises determining that the electronic tracking device is not paired with any Bluetooth beacon of the plurality of Bluetooth beacons in the first wireless network, and, in response to determining that the electronic tracking device is not paired with any Bluetooth beacon of the plurality of Bluetooth beacons in the first wireless network, determining that the electronic tracking device is not communicatively connected to the first wireless network. After determining that the electronic tracking device is not communicatively connected to the first wireless network, a determination is made that the electronic tracking device is not communicatively connected to the second wireless network; and in response to determining that the electronic tracking device is not communicatively connected to the first wireless network and the second wireless network, determining that the electronic tracking device is not communicatively connected to the one or more wireless networks. In these embodiments, determining that the electronic tracking device is not communicatively connected to the one or more wireless networks involves a stepwise assessment of the device's connection to both the Bluetooth network and the Wi-Fi network.

For example, in a retail store equipped with both a Bluetooth mesh network and a Wi-Fi network, the electronic tracking device can first determine if it is paired with any Bluetooth beacon in the mesh network. While inside the store, the tracking device can maintain pairing with one or more Bluetooth beacons as it moves through different areas. If the device determines that it is no longer paired with any beacon in the Bluetooth mesh network, it concludes that it is not communicatively connected to the first wireless network.

Once the tracking device determines it is no longer connected to the Bluetooth mesh network, it proceeds to assess its connection to the second wireless network, the Wi-Fi network. For example, if the store's Wi-Fi network covers essentially the same area as the Bluetooth network, the tracking device can still maintain connectivity through a nearby Wi-Fi access point. The tracking device checks whether it can establish a connection with any Wi-Fi access point in the network. If the tracking device determines that it is not connected to any access point, it concludes that it is not communicatively connected to the second wireless network.

In some cases, a tracking device might lose connection to both networks, such as when it is carried outside the store's boundaries. For example, as the device moves toward an exit, it may first lose pairing with Bluetooth beacons and then move out of range of all Wi-Fi access points. Upon determining that it is disconnected from both the Bluetooth mesh network and the Wi-Fi network, the tracking device concludes that it is no longer communicatively connected to the one or more wireless networks. This dual-network configuration can enhance the reliability of the tracking system, as it reduces the likelihood of false disconnection alerts and ensures accurate detection of when the device leaves the designated area.

In some embodiments, before scanning for the Wi-Fi network, the tracking device determines whether it has failed to connect to the Bluetooth network for a predetermined number of attempts. For example, if the tracking device attempts to connect to the Bluetooth network and fails to pair with any beacon six times consecutively, it then proceeds to scan for the Wi-Fi network. This approach can allow the tracking device to confirm that it is genuinely out of range of the Bluetooth network, avoiding unnecessary transitions to Wi-Fi due to temporary connection issues or signal fluctuations.

For example, a tracking device moving through a store might momentarily lose connection to a Bluetooth beacon due to interference or a brief signal drop, such as when passing behind a dense shelving unit. Instead of immediately switching to the Wi-Fi network, the device would attempt multiple reconnections with the Bluetooth network. If it fails a predetermined number of times, the tracking device can conclude that it is no longer within the range of the Bluetooth network and then initiate a scan for available Wi-Fi networks. This process can reduce unnecessary use of the Wi-Fi network, conserving energy and ensuring reliable connectivity while maintaining efficient operation of the tracking system.

In response to determining that the electronic tracking device is not communicatively connected to the one or more wireless networks, the electronic tracking device determines location information of the electronic tracking device (606). In some embodiments, the location information comprise a GPS location of the electronic tracking device.

For example, when using only the Bluetooth network, the tracking device can periodically check whether it is paired with any Bluetooth beacon in the mesh network. As long as the device remains paired with at least one beacon, it can determine its location based on the region covered by that beacon. If the tracking device loses connection to all Bluetooth beacons, it determines that it is no longer connected to the Bluetooth network and proceeds to use its GPS circuitry to acquire precise location data. For example, a tracking device being moved outside the boundaries of the store can detect that it is no longer within range of any Bluetooth beacons. In response, the device activates its GPS functionality to identify its current coordinates and transmit this information to the monitoring system.

When using both the Bluetooth and Wi-Fi networks, the tracking device can first check whether it is paired with any Bluetooth beacon. If the tracking device loses connection with the Bluetooth network, it then attempts to connect to the Wi-Fi network. If the tracking device successfully connects to the Wi-Fi network, it can use the network to determine its approximate location within the store, such as by identifying the specific Wi-Fi access point it is connected to. However, if the device is unable to connect to either the Bluetooth or Wi-Fi networks, it can activate its GPS functionality to determine its precise location. For example, if the device is carried outside the range of both Bluetooth beacons and Wi-Fi access points, it relies on GPS to track its position and transmit the location data to ensure continuous monitoring.

In some embodiments, before activating the GPS functionality, the tracking device determines whether it has failed to connect to the Wi-Fi network for a predetermined number of attempts. This approach can help the device avoid unnecessarily activating the GPS functionality, which typically consumes more power than other network-based methods of determining location. By attempting multiple connections to the Wi-Fi network, the tracking device can ensure that it only activates GPS functionality when it is truly out of range of both Bluetooth and Wi-Fi networks.

For example, a tracking device may lose connection with the Bluetooth network while transitioning out of the store's main floor to an outdoor area. Before activating the GPS functionality, the tracking device can attempt to connect to the store's Wi-Fi network, such as by scanning for available access points. If it fails to connect on the first attempt, the tracking device retries multiple times, e.g., up to three attempts over a few seconds. If, after these predetermined attempts, the tracking device is still unable to connect to the Wi-Fi network, it can conclude that it is no longer within range of either wireless network and proceed to activate its GPS functionality to determine its precise location.

In some embodiments, the electronic tracking device determines that a predetermined time period has lapsed without detecting any movement of the electronic tracking device during the predetermined time period. In such embodiments, in response to determining that the predetermined time period has lapsed without detecting any movement of the electronic tracking device, the electronic tracking device determines location information of the electronic tracking device.

For example, if the tracking device has been stationary and in idle mode for a predefined duration, such as 30 minutes, it can periodically wake up to confirm its location and report it to the central monitoring system. This functionality can ensure that the system remains aware of the tracking device's position, even if it has not been moved. In response to this wake-up event, the tracking device can activate its Bluetooth or Wi-Fi circuitry to determine if it is still within the range of the designated wireless networks. If it is connected to one or more networks, the tracking device can use this information to approximate its location and report it.

If the tracking device determines that it is not connected to any Bluetooth or Wi-Fi network, it can then activate its GPS module to determine its precise location. For example, a stationary device placed in a warehouse might remain in idle mode while conserving battery, but after a predetermined time without movement, it wakes up, identifies its position using available networks or GPS, and sends a location update to ensure its status is recorded.

The electronic tracking device sends the location information of the electronic tracking device (608). In some embodiments, the tracking device transmits the location data, such as GPS coordinates or network-based location details, to a central monitoring system or database for tracking and logging purposes. The transmission can be conducted over available communication networks, such as Bluetooth, Wi-Fi, or cellular networks, depending on the device's configuration and current connectivity.

For example, if the tracking device determines its GPS location after losing connection with Bluetooth and Wi-Fi networks, it can transmit its precise latitude and longitude to the monitoring system via a cellular connection. This transmission could include additional metadata, such as the time of the location fix, the device's unique identifier, and the status of its connectivity to any nearby networks.

In some examples, when the tracking device moves out of range of its designated wireless network(s), it can reconnect to a new beacon, such as a cell phone equipped with BLE functionality. For example, a mobile device configured to track the electronic tracking device can act as a beacon. When the tracking device comes within range of the cell phone, the tracking device can establish a BLE connection, enabling further interactions between the tracking device and the phone.

Once the tracking device reconnects to the cell phone, the cell phone can serve as a relay or controller to manage the tracking device's operations. For example, upon establishing the BLE connection, the tracking device can activate its GPS functionality to determine its precise location. The GPS coordinates can then be reported to the monitoring system through the cell phone's internet connection, such as via a cellular network or Wi-Fi. This process can allow the tracking device to resume communication and location reporting even after it has moved out of the range of its original Bluetooth network.

In some embodiments, when the tracking device is out of range of specified wireless networks, the tracking device generates notifications corresponding to predefined proximity thresholds. In some examples, the tracking device can be configured to evaluate real-time distance measurements and trigger alerts at varying levels, such as low, medium, or high, based on the relative position of the tracking device to the wireless networks.

Distance thresholds for each alert level can be predefined, enabling configurations such as a high alert for distances exceeding 50 meters from the wireless network, a medium alert for distances between 20 and 50 meters, and a low alert for distances less than 20 meters. The system can support multiple notification modalities, including auditory, vibrational, or visual signals, to accommodate different user preferences and environmental conditions. This configuration can provide an efficient and reliable method for proximity-based alerting, applicable to use cases such as safety monitoring, asset tracking, and zone-based access management.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media, and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for monitoring an electronic tracking device, comprising:
determining, by an electronic tracking device, that the electronic tracking device is moving;
after determining that the electronic tracking device is moving, determining, by the electronic tracking device, that the electronic tracking device is not communicatively connected to one or more wireless networks;
in response to determining that the electronic tracking device is not communicatively connected to the one or more wireless networks, determining, by the electronic tracking device, location information of the electronic tracking device; and
sending, by the electronic tracking device, the location information.

2. The method according to claim 1, wherein the location information comprises a Global Positioning System (GPS) location of the electronic tracking device.

3. The method according to claim 1, wherein:
determining, by an electronic tracking device, that the electronic tracking device is moving comprises determining that the electronic tracking device is moving at a first time point; and
determining, by the electronic tracking device, that the electronic tracking device is not communicatively connected to one or more wireless networks comprises determining that the electronic tracking device is not communicatively connected to the one or more wireless networks at a second time point, wherein a time period between the first time point and the second time point is a predetermined time period.

4. The method according to claim 1, further comprising:
determining, by the electronic tracking device, that a predetermined time period has lapsed without detecting any movement of the electronic tracking device during the predetermined time period; and
in response to determining that the predetermined time period has lapsed without detecting any movement of the electronic tracking device during the predetermined time period, determining, by the electronic tracking device, location information of the electronic tracking device.

5. The method according to claim 1, wherein the one or more wireless networks comprise a Bluetooth mesh network comprising a plurality of Bluetooth beacons.

6. The method according to claim 5, wherein determining that the electronic tracking device is not communicatively connected to the one or more wireless networks comprises:
determining that the electronic tracking device is not paired with any Bluetooth beacon of the plurality of Bluetooth beacons in the Bluetooth mesh network.

7. The method according to claim 1, wherein the one or more wireless networks comprise a first wireless network and a second wireless network, the first wireless network is a Bluetooth mesh network comprising a plurality of Bluetooth beacons, and the second wireless network is a Wi-Fi network.

8. The method according to claim 7, wherein determining that the electronic tracking device is not communicatively connected to the one or more wireless networks comprises:
determining that the electronic tracking device is not paired with any Bluetooth beacon of the plurality of Bluetooth beacons in the first wireless network;
in response to determining that the electronic tracking device is not paired with any Bluetooth beacon of the plurality of Bluetooth beacons in the first wireless network, determining whether the electronic tracking device is communicatively connected to the first wireless network; and
in response to determining that the electronic tracking device is not communicatively connected to the first wireless network, determining that the electronic tracking device is not communicatively connected to the second wireless network.

9. An electronic tracking device, comprising:
a motion sensor;
a Bluetooth circuitry;
a Global Positioning System (GPS) circuitry;
at least one processor; and
one or more memories coupled to the at least one processor and storing programming instructions for execution by the at least one processor to:
determine, using the motion sensor, that the electronic tracking device is moving;
after determining that the electronic tracking device is moving, determine, using at least the Bluetooth circuitry, that the electronic tracking device is not communicatively connected to one or more wireless networks;
in response to determining that the electronic tracking device is not communicatively connected to the one or more wireless networks, determine, using the GPS circuitry, location information of the electronic tracking device; and
send the location information.

10. The electronic tracking device according to claim 9, wherein the location information comprises a GPS location of the electronic tracking device.

11. The electronic tracking device according to claim 9, wherein:
determining that the electronic tracking device is moving comprises determining that the electronic tracking device is moving at a first time point; and
determining that the electronic tracking device is not communicatively connected to one or more wireless networks comprises determining that the electronic tracking device is not communicatively connected to the one or more wireless networks at a second time point, wherein a time period between the first time point and the second time point is a predetermined time period.

12. The electronic tracking device according to claim 9, wherein the programming instructions are for execution by the at least one processor further to:
determine that a predetermined time period has lapsed without detecting any movement of the electronic tracking device during the predetermined time period; and
in response to determining that the predetermined time period has lapsed without detecting any movement of the electronic tracking device during the predetermined time period, determine location information of the electronic tracking device.

13. The electronic tracking device according to claim 9, wherein the one or more wireless networks comprise a Bluetooth mesh network comprising a plurality of Bluetooth beacons.

14. The electronic tracking device according to claim 13, wherein determining that the electronic tracking device is not communicatively connected to the one or more wireless networks comprises:
determining that the electronic tracking device is not paired with any Bluetooth beacon of the plurality of Bluetooth beacons in the Bluetooth mesh network.

15. The electronic tracking device according to claim 9, wherein the one or more wireless networks comprise a first wireless network and a second wireless network, the first wireless network is a Bluetooth mesh network comprising a plurality of Bluetooth beacons, and the second wireless network is a Wi-Fi network.

16. The electronic tracking device according to claim 15, wherein determining that the electronic tracking device is not communicatively connected to the one or more wireless networks comprises:
determining that the electronic tracking device is not paired with any Bluetooth beacon of the plurality of Bluetooth beacons in the first wireless network;
in response to determining that the electronic tracking device is not paired with any Bluetooth beacon of the plurality of Bluetooth beacons in the first wireless network, determining whether the electronic tracking device is communicatively connected to the first wireless network; and
in response to determining that the electronic tracking device is not communicatively connected to the first wireless network, determining that the electronic tracking device is not communicatively connected to the second wireless network.

17. A non-transitory computer-readable storage medium, wherein the non-transitory computer-readable storage medium stores programming instructions for execution by at least one processor of an electronic tracking device to:
determine that the electronic tracking device is moving;
after determining that the electronic tracking device is moving, determine that the electronic tracking device is not communicatively connected to one or more wireless networks;
in response to determining that the electronic tracking device is not communicatively connected to the one or more wireless networks, determine location information of the electronic tracking device; and
send the location information.

18. The non-transitory computer-readable storage medium according to claim 17, wherein the location information comprises a Global Positioning System (GPS) location of the electronic tracking device.

19. The non-transitory computer-readable storage medium according to claim 17, wherein:
determining that the electronic tracking device is moving comprises determining that the electronic tracking device is moving at a first time point; and
determining that the electronic tracking device is not communicatively connected to one or more wireless networks comprises determining that the electronic tracking device is not communicatively connected to the one or more wireless networks at a second time point, wherein a time period between the first time point and the second time point is a predetermined time period.

20. The non-transitory computer-readable storage medium according to claim 17, wherein the programming instructions are for execution by the at least one processor further to:
determine that a predetermined time period has lapsed without detecting any movement of the electronic tracking device during the predetermined time period; and
in response to determining that the predetermined time period has lapsed without detecting any movement of the electronic tracking device during the predetermined time period, determine location information of the electronic tracking device.
